(19) United States
(12) Patent Application Publication
(10) Pub. No.: US 2005/0221011 A1
(43) Pub. Date: Oct. 6, 2005

(54) Process for producing semifinished products and moldings

(75) Inventors: Leonhard Eichner, Ludwigshafen (DE); Rainer Scheidhauer, Hassloch (DE); Juliane Kruesemann, Ludwigshafen (DE); Manfred Lahm, Hellertshausen (DE); Rainer Dittrich, Kusel (DE); Heribert Jungmann, Kaiserslautern (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/067,711

(22) Filed: Mar. 1, 2005

(30) Foreign Application Priority Data
Mar. 31, 2004 (DE) 102004016646.3

(51) Int. Cl. B05D 3/02

(52) U.S. Cl. 427/372.2; 427/402

(57) ABSTRACT

Process for producing semifinished products from sheet-like fiber structures and from binders, by first (i) treating a sheet-like fiber structure with a binder and, if appropriate, drying it to a moisture content of from 4 to 30% by weight, (ii) coating the surface of the resultant treated fiber structure on one or both sides with a curable binder, and (iii) drying the coated fiber structure to a residual moisture content of from 4 to 30% by weight, to give a semifinished product, and the resultant semifinished product, process for producing moldings via heating of the semifinished product to a temperature above the temperature at which the binders crosslink, and use of the moldings as internal parts for motor vehicles, as packing material, as single-use tableware, as office accessories, as trays, as decorative parts in the furniture industry, or else as inserts for closets, or drawers, or rear walls of furniture.

The invention relates to a process for the production of semifinished products and of moldings from sheet-like fiber structures and from binders, to the resultant semifinished products, to moldings produced therefrom, and to their use.

It is known that sheet-like fiber structures, such as fiber nonwovens composed of glass fibers or cellulose fibers, can be consolidated mechanically via needling or hydroentangling of a wet-laid or air-laid or carded nonwoven, or via chemical consolidation of a nonwoven using polymeric binders. In order to increase the resistance of the nonwovens to moisture and heat, use is often made of binders made of formaldehyde condensates, which emit formaldehyde during the processing and the use of nonwovens consolidated therewith.

Formaldehyde-free polymeric binders are also known for the consolidation of fiber nonwovens. For example, U.S. Pat. No. 4,076,917 describes binders which comprise polymers having carboxylic acid groups or having anhydride groups, and comprise β-hydroxyalkylamides as crosslinking agents.

EP-A-0 445 578 discloses sheets composed of fine-particle materials, such as glass fibers, which have been consolidated with the aid of binder mixtures composed of high-molecular-weight polycarboxylic acids and of polyhydric alcohols, of alkanolamines, or of polyamines.

Other formaldehyde-free, aqueous binders for producing consolidated fiber nonwovens, in particular glass fiber nonwovens, are known from EP-A-0 583 086. The binders comprise a polycarboxylic acid having at least two carboxy or anhydride groups, at least one polyol, and a phosphorus compound as reaction accelerator. According to the teaching of EP-A-0 651 088, these binder mixtures are used for the consolidation of cellulose substrates.

WO-A-97/31036 discloses formaldehyde-free, aqueous binders for fiber nonwovens, in particular for glass fiber nonwovens. The binders comprise (A) a polymer composed of from 5 to 100% by weight of an ethylenically unsaturated anhydride or of an ethylenically unsaturated dicarboxylic acid whose carboxy groups can form an anhydride group, and (B) an alkanolamine having at least two hydroxy groups, and also comprise a phosphorus compound as reaction accelerator. The bonded fiber nonwovens are used, by way of example, to produce roof sheeting, insulating materials, floorcoverings, and pan cleaners.

WO-A-97/31059 likewise discloses binders of this type for fibers or shavings, for the production of moldings. The gel content of the binders after drying (at 50° C., for 72 hours) to give a film of thickness from 0.3 to 1 mm, followed by 15 minutes of curing at 130° C. in air is more than 50% by weight.

According to WO-A-97/31060, coatings used for molding comprise formaldehyde-free aqueous binders which comprise (A) a polymer obtained via free-radical polymerization and composed of from 5 to 100% by weight of an ethylenically unsaturated anhydride or of an ethylenically unsaturated dicarboxylic acid whose carboxylic acid groups can form an anhydride group, and comprise (B) an alkanolamine having at least two hydroxy groups. The moldings are preferably sheets, e.g. composed of organic or inorganic fibers or mineral fillers, in each case consolidated with a polymer binder.

DE-A-199 49 591 discloses a heat-curable composition which comprises at least one copolymer containing carboxy groups, at least one relatively high-functionality β-hydroxyalkylamine, and, if appropriate, at least one surfactant. By way of example, these compositions are used as binders for substrates, in particular for moldings composed of fibrous or granular materials. To produce moldings, by way of example, the substrates are treated with the composition mentioned, and the material is then cured via heating to temperatures in the range from 75 to 250° C.

WO-A-01/27163 discloses an aqueous polymer dispersion which comprises dispersed polymer particles of at least one polymer A1, obtainable via free-radical emulsion polymerization in the presence of a polymer A2, which is composed of from 50 to 99.5% by weight of at least one ethylenically unsaturated mono- and/or dicarboxylic acid and of from 0.5 to 50% by weight of at least one ethylenically unsaturated compound from the group of esters of ethylenically unsaturated monocarboxylic acids, and the half-esters and the diesters of ethylenically unsaturated dicarboxylic acids with an amine having at least one hydroxy group. The aqueous polymer dispersions are used as heat-curable binders for substrates, preferably for moldings composed of fibrous or granular materials. By way of example, these polymer dispersions can be used to impregnate paper, followed by drying, to give laminates for decorative applications. In a second step, these are laminated, with pressure and heat, onto the substrate to be coated, the conditions here being selected in such a way that the binder hardens.

DE-A-199 17 965 discloses a radiation-curable composite layered sheet or film composed of at least one substrate layer and one outer layer, which is composed of a radiation-curable composition which comprises a binder with a glass transition temperature above 40° C. A method of obtaining these composites applies a radiation-curable composition in the form of a melt, solution or dispersion to a substrate layer, and then cures this layer via exposure to radiation. The substrate layer serves as carrier and is intended to ensure that the composite has long lasting high toughness. It is preferably composed of a thermoplastic polymer, such as polymethyl methacrylate, acrylonitrile-butadiene-styrene polymers, acrylic-styrene-acrylonitrile copolymers, or polycarbonates, and can comprise an adhesive layer on the reverse side. The composite films are used to coat motor vehicle parts, examples of those which may be used being wheel surrounds, door panels, bumpers, and spoilers.

Components for automobiles are also produced from bonded and coated fiber nonwovens. For example, a nonwoven composed of a blend of natural fibers and synthetic fibers is coated on one or both sides with polyurethane resins or with epoxy resins, the coated nonwoven is then pressed in a heated press to give automotive moldings, such as automotive door panels, parcel shelves, instrument panels, or side members of doors. The moldings are further processed either directly or mostly elsewhere. The further processing consists in applying a decorative film to these moldings with the aid of an adhesive.

DE-A-1 02 33 521.4 discloses a multilayer coating on a substrate such as paper, plastic, or metal, using at least one radiation-curable lacquer system and at least one elastic intermediate layer having a glass transition temperature T_{g} of −20° C. or below and arranged between the substrate and the radiation-curable lacquer system. These multilayer coatings are used for the coating of buildings, or internal coatings, or for coatings on vehicles or on aircraft.

An object underlying the present invention is to provide a simpler and less expensive process for producing semifinished products and moldings, in particular components for automobiles.

According to the invention, the object is achieved by a process for the production of semifinished products from sheet-like fiber structures and from binders, by first
(i) treating a sheet-like fiber structure with a binder,
(ii) coating the surface of the resultant treated fiber structure on one or both sides with a curable binder, and
(iii) drying the coated fiber structure to a residual moisture content of from 4 to 30% by weight.

In one embodiment of the inventive process, the sheet-like fiber structure is dried to a moisture content of from 4 to 30% by weight, preferably from 8 to 20% by weight, after the treatment with a binder according to step (i) of the process, and the surface of the binder-treated fiber structure is then coated on one or both sides with a curable binder according to step (ii) of the process, and the coated fiber structure is then dried in step (iii) of the process to a residual moisture content of from 4 to 30% by weight, preferably from 8 to 20% by weight. This gives a semifinished product in the form of a flexible mat which, if the thickness is appropriate, can be rolled up.

The drying of the fiber structure treated with a binder according to step (i) of the process, and also the drying of the coated fiber structure in step (iii) of the process, is preferably carried out at a temperature below the temperature at which the binders crosslink. This ensures that the binders do not harden at this stage, or at most harden only to some extent, and that the semifinished products obtained are still flexible. The temperature at which the individual binders crosslink depends on the nature of the binder used. The crosslinking temperature of binders (also termed the curing temperature of the binders) is frequently stated in technical data sheets by the producers of the binders. It may moreover easily be determined by heating specimens of the binders to relatively high temperatures and determining the temperature at which the binders become insoluble in a particular solvent, e.g. water or dimethylformamide. The heating period also affects the degree of crosslinking of the binders. As the degree of crosslinking increases, the binder is cured, the result being loss of the initial flexibility of the semifinished products. If the binder used comprises two-component systems, such as epoxy resins, the hardening of the binder begins even at room temperature, and, by way of example, phenolic resins crosslink at temperatures above 40° C., while, for example, aqueous dispersions based on polymers composed of styrene and of at least one acrylate, modified with a polycarboxylic acid and with a polyhydric alcohol as crosslinking components begin to crosslink at a temperature of 130° C. Other polymer dispersions used as binder have relatively high crosslinking temperatures, e.g. from 150 to 180° C.

Step (i) of the process consists in known measures for the production of the bonded fiber nonwovens. Use is made here of an amount of from 0.5 to 40% by weight, preferably from 15 to 30% by weight, based on the solids content of the binders and sheet-like fiber structures, of at least one binder. The binder serves to consolidate the fiber structures. The method of its use may be via spraying, saturation, impregnation, or padding, or via treatment of the fiber structure with a foam.

Fiber structures in the present context are textile sheet structures, such as wovens, knitteds, or nonwovens. They may be composed of fibers or shavings, or of a mixture of these. An example of these structures is provided by wet- or air-laid or carded nonwovens. The nonwovens may, by way of example, be composed of natural or synthetic fibers, or of mixtures of natural and synthetic fibers, or else of shavings composed of wood. Examples of natural fibers are fruit fibers, seed fibers, and stalk fibers, for example sisal, jute, hemp, kenaf, flax, cellulose, and cotton, and also banana fibers, wool, hair, and cork. Examples of synthetic fibers are fibers composed of polyester, of polyacrylonitrile, of polyamide, of carbon, of polyvinyl chloride, of polyolefins, such as polyethylene and polypropylene, or else of aramid, and inorganic fibers, such as mineral fibers and glass fibers. The preferred starting material is unbonded nonwovens composed of renewable raw materials, such as hemp, kenaf, sisal, jute, or flax, or a mixture of these fibers with one another, e.g. a mixture composed of hemp and kenaf, or a mixture composed of hemp and flax or, respectively, jute. Another preferred embodiment of the invention uses a mixture composed of natural fibers and of synthetic fibers, such as polyester fibers, aramid fibers, carbon fibers, or polyolefin fibers, or a mixture composed of synthetic fibers and glass fibers, e.g. a mixture composed of polyester fibers and glass fibers. Other interesting mixtures are those composed of natural fibers, such as sisal or hemp, together with synthetic fibers, such as polyester fibers and/or glass fibers. If natural fibers are used in the sheet-like fiber structures, their proportion is preferably more than 50% by weight, e.g. from 55 to 75% by weight.

By way of example, the weight per unit area of the sheet-like fiber structures is from 80 to 5000 g/m², preferably from 500 to 2000 g/m². The weight per unit area of the fiber structures is mostly from 800 to 1600 g/m².

Heat-curable binders for the consolidation of fiber nonwovens are known. By way of example, they are described in the prior-art publications mentioned and hereby incorporated by way of reference into the disclosure content of the present invention, namely U.S. Pat. No. 4,076,917, EP-A-0 445 578, EP-A-0 583 086, EP-A-0 651 088, WO-A-97/31036, page 4, line 12 to page 12, line 14, WO-A-97/31059, page 2, line 22 to page 12, line 5, WO-A-97/31060, page 3, line 8 to page 12, line 36, DE-A-199 49 591, page 3, line 5 to page 7, line 38, WO-A-01/27163, page 5, line 34 to page 22, line 2, and also DE-A-199 17 965, which discloses radiation-curable binders.

Heat-curable binders which may be used, other than the binders described in the abovementioned publications, are any of the curable binders which are described in the literature for the consolidation of fiber nonwovens, and/or are used in industry for this purpose, examples being heat-curable resins based on phenol and formaldehyde, melamine-formaldehyde resins, urea-formaldehyde resins, single- and two-component epoxy-resin- or polyurethane-based systems, polyacrylates, polymethacrylates, polyvinyl acetate, styrene-acrylate copolymer dispersions, styrene-methacrylate copolymer dispersions, styrene-butadiene-(meth)acrylic acid copolymer dispersions, and also mixtures composed of the dispersions mentioned with a mixture composed of a polycarboxylic acid and of a polyhydric alcohol as crosslinking component.

Examples of heat-curable binders whose use is preferred are mixtures composed of
(a) a polymer obtainable via free-radical polymerization and containing, as comonomer, from 5 to 100% by weight of an ethylenically unsaturated carboxylic anhydride or of an ethylenically unsaturated dicarboxylic acid whose carboxylic acid groups can form an anhydride group, and
(b) at least one alkanolamine which contains at least two hydroxy groups in the molecule.

Specific examples of these mixtures are aqueous solutions comprising from about 40 to 60% by weight of solids and composed of a copolymer composed of 80% by weight of acrylic acid and 20% by weight of maleic acid and having a molecular weight M_{w} of 15 000 to 900 000, combined with triethanolamine, or aqueous solutions composed of a copolymer composed of 55% by weight of acrylic acid and 45% by weight of maleic acid in combination with triethanolamine. These binders may, if appropriate, comprise an esterification catalyst and/or a compound containing bonded phosphorus, e.g. hypophosphorous acid, as reaction accelerator.

The copolymer (a) described above may also, by way of example, be composed of
from 50 to 99.5% by weight of at least one ethylenically unsaturated mono- or dicarboxylic acid,
from 0.5 to 50% by weight of at least one ethylenically unsaturated compound from the group of the esters of ethylenically unsaturated monocarboxylic acids and the monoesters and the diesters of ethylenically unsaturated dicarboxylic acids with an amine having at least one hydroxy group, and
up to 20% by weight of another monomer.

Heat-curable aqueous compositions which comprise at least one copolymer (a) and at least one alkanolamine or relatively high-functionality β-hydroxyalkylamine may, if appropriate, also comprise at least one surfactant.

Other heat-curable binders are based on aqueous mixtures of
polycarboxylic acids, such as polyacrylic acid, polymethacrylic acid, copolymers composed of acrylic acid and maleic acid, copolymers composed of methacrylic acid and maleic acid, copolymers composed of ethylene and maleic acid, styrene and maleic acid, or copolymers composed of acrylic acid or methacrylic acid and of esters of acrylic or methacrylic acid with preferably monohydric C₁-C₂₄ alcohols, where the polycarboxylic acids have a K value of from 50 to 100 (measured in the non-neutralized form of the polycarboxylic acids by the method of H. Fikentscher in dimethylformamide at 25° C. and at a polymer concentration of 0.1% by weight)
polyhydric alcohols, such as trimethylolpropane, glycerol, 2-hydroxymethyl-1,4-butanediol, or polyvinyl alcohol, and/or polyamines, and/or alkanolamines.

The amounts used of polycarboxylic acids, polyhydric alcohols, alkanolamines, and polyamines are preferably such that the acid function number is equivalent to the total number of alcoholic hydroxy and alcoholic amine functions, cf. EP-A-0 445 578. Other suitable binders are those composed of an aqueous solution of a polycarboxylic acid (homo- or copolymer), preferably with a molecular weight M_{w} of 10 000 or below, and of a polyol, such as triethanolamine, and in which the ratio of the equivalents of hydroxy groups to equivalents of carboxy groups is in the range from 0.4:1 to 1.0:1, cf. EP-A-0 990 727.

In stages (i) and (ii) of the inventive process it is particularly advantageous to use binders marketed by BASF Aktiengesellschaft with the trade mark Acrodur®. An example here is an aqueous styrene-acrylate polymer dispersion modified with a polycarboxylic acid and with a polyhydric alcohol as crosslinking component. It crosslinks at a temperature as low as 130° C. However, in order to achieve high production rates, the preferred crosslinking temperatures used are from 180 to 200° C. Another formaldehyde-free binder used for wood fibers, natural fibers, and cork, and also suitable for the consolidation of glass fibers and mineral fibers, is commercially available in the form of a colorless to slightly yellowish, clear, aqueous solution of a modified polycarboxylic acid with a polyhydric alcohol as crosslinking component. It crosslinks at drying temperatures of from about 160 to 180° C. In order to achieve a high degree of crosslinking it is advisable to optimize the production rate as appropriate for the crosslinking time and crosslinking temperature.

The binder used preferably comprises low-formaldehyde-content or formaldehyde-free heat-curable products. In the present context, low-formaldehyde-content means that the binders comprise no substantial amounts of free formaldehyde, and also that no substantial amounts of formaldehyde are liberated during drying or curing of the materials treated with the binders. These binders generally comprise <100 ppm of formaldehyde.

Particular preference is given to formaldehyde-free binders which comprise at least one polycarboxylic acid and at least one polyhydric alcohol, and/or alkanolamine or polyamine. Compositions which comprise these binders may, if appropriate, also comprise other formaldehyde-free binders, e.g. polyacrylates, which are marketed by BASF Aktiengesellschaft with the trade mark Acronal®.

Any of the curable binders known for the binding of fiber nonwovens and referred to above may be used as binder in stages (i) and (ii) of the process. For example, stage (i) of the process may use a polyacrylate and stage (ii) of the process may use a mixture composed of a polycarboxylic acid and of a polyhydric alcohol. Stages (i) and (ii) of the process preferably use binders of the type Acrodur® based on at least one polycarboxylic acid and on at least one polyhydric alcohol. Use may also be made of mixtures composed of at least one curable binder and of at least one other binder.

In stage (ii) of the process, the binder-treated sheet-like fiber structure is coated with a binder, if appropriate after drying to a moisture content of from 4 to 30% by weight. In contrast to the consolidation of fiber nonwovens—and therefore also in contrast to step (i) of the process—the intention is that the binder used in step (ii) of the process remain substantially on the surface of the fibrous sheet structure, or penetrate only a very small portion thereof. The preferred method of achieving this coating consists, in step (ii) of the process, in using a foam-like, curable binder, or a paste-like, curable binder.

Foam-like, curable binders can be obtained, by way of example, by foaming a solution comprising aqueous, curable binders and preferably comprising a surfactant, using the mechanical method of foaming. However, it is also possible to dissolve an inert gas, e.g. nitrogen or carbon dioxide, in this type of solution under pressure, and then depressurize the mixture through a nozzle, with foaming. Examples of the foam densities of foam-like, curable binders used in the inventive process are from 150 to 500 g/l, preferably from 250 to 450 g/l. The foam densities of the curable binder preparations are mostly in the range from 300 to 400 g/l.

If a paste-like, curable binder is used in step (ii) of the process for the coating of the fibrous sheet-like structure, the viscosity of the binder preparation is adjusted, e.g. via addition of at least one thickener, to a value of from 500 to 5000 mPas, preferably from 1000 to 4000 mPas. Viscosities of the curable binder used for the surface coating process are usually from 1500 to 3000 mPas.

The amount of curable binders used in step (ii) of the process is, by way of example, from 0.5 to 30% by weight, preferably from 1 to 20% by weight, based on the solids content of the product obtained in stage (i) of the process. The amounts of curable binder used for the coating in step (ii) of the process are mostly in the range from 2 to 10% by weight, based on the solids content of the product obtained in stage (i) of the process.

The binders may, if appropriate, comprise additives, e.g. hydrophobicizing agents, such as siloxanes, antifoams, fillers, such as perlites, flame retardants, such as aluminum silicates, aluminum hydroxides, borates, and/or phosphates, starch, or colorants.

The curable binders used for the coating process in stage (ii) of the process preferably comprise a colorant. Examples of suitable colorants are the pigment preparations mentioned below, in particular aqueous pigment preparations. Examples of the amount of the colorants used are from 0.1 to 50% by weight, preferably from 0.5 to 10% by weight, based on the binder. The colorants may be added to the binder prior to the foaming process, or else incorporated into the foamed binders. If a paste is used for the coating process, the colorant is advantageously added to the binder prior to its thickening, and a thickener is added to the composition only after the homogenization process. It is also possible to use a colorant to color the binder used in stage (i) of the process.

Examples of suitable colorants are aqueous pigment preparations, for example preferably in fine-particle form. These preparations comprise pigments indicated by “(A)” in the text below. The pigments usually have average particle sizes of from 0.1 to 5 μm, in particular from 0.1 to 3 μm, and especially from 0.1 to 1 μm.

The organic pigments are usually organic non-white color pigments and organic black pigments. Inorganic pigments may likewise be color pigments (non-white color pigments, black pigments, and white pigments) or else luster pigments.

Some examples of suitable organic color pigments which may be mentioned are:

Monoazo Pigments:
C.I. Pigment Brown 25;
C.I. Pigment Orange 5, 13, 36, 38, 64, and 67;
C.I. Pigment Red 1, 2, 3, 4, 5, 8, 9, 12, 17, 22, 23, 31, 48:1, 48:2, 48:3, 48:4, 49, 49:1, 51:1, 52:1, 52:2, 53, 53:1, 53:3, 57:1, 58:2, 58:4, 63, 112, 146, 148, 170, 175, 184, 185, 187, 191:1, 208, 210, 245, 247, and 251;
C.I. Pigment Yellow 1, 3, 62, 65, 73, 74, 97, 120, 151, 154, 168, 181, 183, and 191;
C.I. Pigment Violet 32;

Disazo Pigments:
C.I. Pigment Orange 16, 34, 44, and 72;
C.I. Pigment Yellow 12, 13, 14, 16, 17, 81, 83, 106, 113, 126, 127, 155, 174, 176, 180, and 188;

Disazo Condensation Pigments:
C.I. Pigment Yellow 93, 95, and 128;
C.I. Pigment Red 144, 166, 214, 220, 221, 242, and 262;
C.I. Pigment Brown 23, and 41;
Anthanthrone pigments: C.I. Pigment Red 168;
Anthraquinone pigments: C.I. Pigment Yellow 147, 177, and 199;
   C.I. Pigment Violet 31;
Anthrapyrimidine pigments: C.I. Pigment Yellow 108;

Quinacridone Pigments:
C.I. Pigment Orange 48, and 49;
C.I. Pigment Red 122, 202, 206, and 209; C.I. Pigment Violet 19;
Quinophthalone pigments: C.I. Pigment Yellow 138;
Diketopyrrolopyrrole pigments: C.I. Pigment Orange 71, 73, and 81; C.I. Pigment
   Red 254, 255, 264, 270, and 272;
Dioxazine pigments: C.I. Pigment Violet 23, and 37; C.I. Pigment Blue 80;
Flavanthrone pigments: C.I. Pigment Yellow 24;
Indanthrone pigments: C.I. Pigment Blue 60, and 64;
Isoindoline pigments: C.I. Pigment Orange 61, and 69; C.I. Pigment Red 260;
   C.I. Pigment Yellow 139, and 185;
Isoindolinone pigments: C.I. Pigment Yellow 109, 110, and 173;
Isoviolanthrone pigments: C.I. Pigment Violet 31;
Metal complex pigments: C.I. Pigment Red 257; C.I. Pigment Yellow 117, 129, 150, 153, and 177; C.I. Pigment Green 8;
Perinone pigments: C.I. Pigment Orange 43; C.I. Pigment Red 194;
Perylene pigments: C.I. Pigment Black 31, and 32; C.I. Pigment Red 123, 149, 178, 179, 190, and 224; C.I. Pigment Violet 29;
Phthalocyanine pigments: C.I. Pigment Blue 15, 15:1, 15:2, 15:3, 15:4, 15:6, and 16;
   C.I. Pigment Green 7, and 36;
Pyranthrone pigments: C.I. Pigment Orange 51; C.I. Pigment Red 216;
Pyrazoloquinazolone pigments: C.I. Pigment Orange 67; C.I. Pigment Red 251;
Thioindigo pigments: C.I. Pigment Red 88, and 181; C.I. Pigment Violet 38;
Triarylcarbonium pigments: C.I. Pigment Blue 1, 61, and 62; C.I. Pigment Green 1;
   C.I. Pigment Red 81, 81:1, and 169;
   C.I. Pigment Violet 1, 2, 3, and 27;
C.I. Pigment Black 1 (aniline black);
C.I. Pigment Yellow 101 (aldazine yellow);
C.I. Pigment Brown 22.

Examples of suitable inorganic color pigments are:
White pigments: titanium dioxide (C.I. Pigment White 6), zinc white, pigment grade zinc oxide; zinc sulfide, lithopones;
Black pigments: iron oxide black (C.I. Pigment Black 11), iron manganese black, spinel black (C.I. Pigment Black 27); carbon black (C.I. Pigment Black 7);
Nonwhite color pigments: chromium oxide, chromium oxide hydrate green; chrome green (C.I. Pigment Green 48); cobalt green (C.I. Pigment Green 50); ultramarine green;

Cobalt blue (C.I. Pigment Blue 28, and 36; C.I. Pigment Blue 72); ultramarine blue; manganese blue;

Ultramarine violet; cobalt violet and manganese violet;
iron oxide red (C.I. Pigment Red 101); cadmium sulfoselenide (C.I. Pigment Red 108);
cerium sulfide (C.I. Pigment Red 265); molybdate red (C.I. Pigment Red 104);
ultramarine red;
iron oxide brown (C.I. Pigment Brown 6, and 7), mixed brown, spinel phases and corundum phases (C.I. Pigment Brown 29, 31, 33, 34, 35, 37, 39, and 40), chrome titanium yellow (C.I. Pigment Brown 24), chrome orange;
cerium sulfide (C.I. Pigment Orange 75);
iron oxide yellow (C.I. Pigment Yellow 42); nickel titanium yellow (C.I. Pigment Yellow 53; C.I. Pigment Yellow 157, 158, 159, 160, 161, 162, 163, 164, and 189); chrome titanium yellow; spinel phases (C.I. Pigment Yellow 119); cadmium sulfide and cadmium zinc sulfide (C.I. Pigment Yellow 37, and 35); chrome yellow (C.I. Pigment Yellow 34); bismuth vanadate (C.I. Pigment Yellow 184).

The luster pigments are lamellar pigments of single- or multiphase structure, the color play of which is determined by the interplay of interference, reflection, and absorption phenomena. Examples which may be mentioned are aluminum lamallae and lamellae of aluminum, iron oxide, or mica, in each case with a single or multiple coating, in particular of metal oxides.

The pigments (A) are generally used in the form of solvent-containing, in particular aqueous colorant preparations which comprise, by way of example, from 10 to 70% by weight, preferably from 10 to 60% by weight, of at least one pigment.

Other colorant preparations suitable for the coloring of the binders are those which comprise at least one dye (B). Materials suitable here are in particular dyes which are soluble in water or in a water-miscible or water-soluble organic solvent. If use is made of a mixture composed of a pigment (A) and of a dye (B) to color the binders, each of the dyes (B) used preferably has a shade comparable with that of the pigments (A), because this method can achieve particularly intense coloring of the binders and, respectively, of the moldings. However, it is also possible to use dyes (B) whose shade deviates, thus making it possible to tint the color.

Cationic and anionic dyes are particularly suitable, preference being given to cationic dyes. Suitable cationic dyes (B) derive in particular from the following series: di- and triarylmethanes, xanthenes, azos, cyanines, azacyanines, methines, acridines, safranines, oxazines, indulines, nigrosins, and phenazines, preference being given to dyes from the following series: azos, triarylmethanes, and xanthenes.

Individual dyes (B) which may be mentioned are: C.I. Basic Yellow 1, 2 and 37; C.I. Basic Orange 2; C.I. Basic Red 1 and 108; C.I. Basic Blue 1, 7 and 26; C.I. Basic Violet 1, 3, 4, 10, 11 and 49; C.I. Basic Green 1 and 4; C.I. Basic Brown 1 and 4.

Cationic dyes (B) may also be colorants containing external basic groups. Suitable examples here are C.I. Basic Blue 15 and 161.

Other cationic dyes (B) which may be used are the corresponding dyebases in the presence of acidic solubilizers. Examples which may be mentioned are: C.I. Solvent Yellow 34; C.I. Solvent Orange 3; C.I. Solvent Red 49; C.I. Solvent Violet 8 and 9; C.I. Solvent Blue 2 and 4; C.I. Solvent Black 7.

Suitable anionic dyes are in particular compounds containing sulfonic acid groups from the azos, anthraquinones, metal complexes, triarylmethanes, xanthenes, and stilbenes, preference being given to dyes from the triarylmethanes, azos, and metal complexes (especially copper complexes, chromium complexes, and cobalt complexes).

Individual examples which may be mentioned are: C.I. Acid Yellow 3, 19, 36 and 204; C.I. Acid Orange 7, 8 and 142; C.I. Acid Red 52, 88, 351 and 357; C.I. Acid Violet 17 and 90; C.I. Acid Blue 9, 193 and 199; C.I. Acid Black 194; anionic chromium complex dyes, such as C.I. Acid Violet 46, 56, 58 and 65; C.I. Acid Yellow 59; C.I. Acid Orange 44, 74 and 92; C.I. Acid Red 195; C.I. Acid Brown 355 and C.I. Acid Black 52; anionic cobalt complex dyes, such as C.I. Acid Yellow 119 and 204; C.I. Direct Red 80 and 81.

It is preferable to use water-soluble dyes. Cations which promote water-solubility and which may be mentioned here are in particular alkali metal cations, such as Li⁺, Na⁺, K⁺, ammonium ions, and substituted ammonium ions, in particular alkanolammonium ions.

The colorant preparations comprise either at least one pigment (A) or at least one dye (B). An example of an amount present of the dye (B) in a solvent-containing preparation is from 0.1 to 10% by weight. In some cases, it is advantageous to use mixtures composed of a pigment (A) and of a dye (B) for the coloring of the binders and, respectively, moldings. These mixtures of colorant preparations then generally comprise amounts of from 0.5 to 10% by weight, preferably from 1 to 8% by weight, of the dye (B) based in each case on the pigment (A). Based on the total weight of the preparation, this corresponds to amounts which are generally from 0.05 to 7% by weight, especially from 0.1 to 5.6% by weight.

Examples of preferred pigment/dye combinations are: C.I. Pigment Blue 15:1 and C.I. Basic Violet 4; C.I. Pigment Green 7 and C.I. Basic Green 4; C.I. Pigment Red 48:2 and C.I. Direct Red 80; C.I. Pigment Black 7 and C.I. Basic Violet 3.

Other than (A) and/or (B), the colorant preparations may also comprise at least one dispersing agent, e.g. non-ionic and/or anionic surface-active additives, or else a mixture of these additives. Preferred non-ionic surface-active additives are in particular based on polyethers. Besides the unmixed polyalkylene oxides, preferably C₂-C₄ alkylene oxides, and phenyl-substituted C₂-C₄ alkylene oxides, in particular polyethylene oxides, polypropylene oxides, and poly(phenylethylene oxides), other materials especially suitable as dispersing agents are block copolymers, in particular polymers having polypropylene oxide blocks and polyethylene oxide blocks, or poly(phenylethylene oxide) blocks and polyethylene oxide blocks, and also random copolymers of these alkylene oxides.

Particularly preferred adducts of alkylene oxide onto at least dihydric alcohols have at least one central polypropylene oxide block, i.e. are derived from a propylene glycol or polypropylene glycol which is first reacted with further propylene oxide and then with ethylene oxide. The content of ethylene oxide in the block copolymers is usually from 10 to 90% by weight. The block copolymers based on polyhydric alcohols generally have average molecular weights Mₙ of from 1000 to 20 000, preferably from 1000 to 15 000. These alkylene oxide block copolymers are known and are available commercially, e.g. with the name Tetronic® and Pluronic® (BASF Aktiengesellschaft).

Anionic surface-active dispersing agents are in particular based on sulfonates, on sulfates, on phosphonates, or on phosphates, or else on surface-active polymers containing carboxylate groups.

Examples of suitable sulfonates are aromatic sulfonates, e.g. p-C₈-C₂₀-alkylbenzenesulfonates, di(C₁-C₈-alkyl)naphthalenesulfonates, and condensates of naphthalenesulfonic acids with formaldehyde, other examples being aliphatic sulfonates, such as C₁₂-C₁₈-alkanesulfonates, C₂-C₈-alkyl esters of α-sulfofatty acid, esters of sulfosuccinic acid, and alkoxy-, acyloxy-, and acylaminoalkanesulfonates. Preference is given to arylsulfonates, particular preference being given to the di(C₁-C₈-alkyl)naphthalenesulfonates. Diisobutyl- and diisopropyinaphthalenesulfonate are very particularly preferred. Examples of suitable sulfates are C₈-C₂₀-alkyl sulfates.

Another important group of anionic surface-active additives which can be used as dispersing agents for dyes and pigments is that of sulfonates, sulfates, phosphonates, and phosphates of the polyethers mentioned as non-ionic additives.

These may be converted into the mono- or diesters of phosphoric acid and esters of phosphonic acid and, respectively, the monoesters of sulfuric acid and esters of sulfonic acid via reaction with phosphoric acid, phosphorus pentoxide, and phosphonic acid and, respectively, sulfuric acid and sulfonic acid. These acidic esters, like the sulfates and sulfonates listed at an earlier stage above preferably take the form of their water-soluble salts, in particular the alkali metal salts, especially sodium salts, and ammonium salts, but they may also be used in the form of the free acids.

Preferred phosphates and phosphonates derive especially from alkoxylated, in particular ethoxylated, fatty and oxo alcohols, alkylphenols, fatty amines, fatty acids, and resin acids, and preferred sulfates and sulfonates are in particular based on alkoxylated, especially ethoxylated, fatty alcohols, alkylphenols, and amines, among which are polyamines, such as hexamethylenediamine. These anionic surface-active additives are known and are available commercially, e.g. with the names Nekal® (BASF), Tamol® (BASF), Crodafos® (Croda), Rhodafac® (Rhodia), Maphos® (BASF), Texapon® (Cognis), Empicol® (Albright & Wilson), Matexil® (ICI), Soprophor® (Rhodia), and Lutensit® (BASF).

Other suitable anionic surface-active additives which may be used as dispersing agents for pigments and for dyes are based on water-soluble polymers containing carboxylate groups. These may advantageously be adapted to the particular application and the particular pigment via adjustment of the ratio between polar and non-polar groups present. Anionic surface-active additives are likewise known per se and available commercially, for example with the names Sokalan® (BASF), Joncryl® (Johnson Polymer), Neoresin® (Avecia), and also Orotan®, and Morez® (Rohm & Haas).

The content of dispersing agent in the colorant preparations is usually from 1 to 50% by weight, in particular from 1 to 40% by weight.

After the coating process, the sheet-like fibrous structure coated with at least one binder and, if appropriate, colored is dried in step (iii) of the process to a residual moisture level of from 4 to 30% by weight, preferably from 10 to 20% by weight. This drying step is preferably carried out at a temperature at which the binders remain uncured, meaning that the temperature is below the crosslinking temperature of the binders. This gives a semifinished product which is flexible. If a colored binder has been used during the coating process in stage (ii) of the process, the individual fibers of the sheeting product have become difficult or impossible to discern. By way of example, the width of the semifinished product may be up to 12 m, depending on the plant available in the technical field, while the thickness of the semifinished product may be in the range from 1 to 50 mm, preferably from 3 to 10 mm. The semifinished product may be cut into individual mats, for example, or be stored in the form of rolls.

The semifinished product may be used in the factory in which it was produced, or else be processed at another site to give the inventive moldings, after shipping to a producer of finished parts. To this end, the semifinished product is heated—generally after prior shaping, e.g. in a press, with deformation—to a temperature which is above the temperature at which the binders crosslink. The temperatures needed for producing the moldings vary, depending on the nature of the binder and on the heating time. The semifinished product is preferably heated in a press to a temperature in the range from 100 to 260° C., preferably from 180 to 220° C., for shaping and curing of the binders.

If a radiation-curable binder has been used in stage (ii) of the process, exposure to high-energy radiation may, if appropriate, also be used to cure the binder, the electro-magnetic radiation used here being in the wavelength range of from 760 nm to 2.5 μm. Examples of suitable radiation sources for the radiation-curing process are low-pressure mercury sources, medium-pressure mercury sources, and also fluorescent tubes, pulsed sources, metal halide sources, or excimer sources.

The result is then cured, rigid moldings which have thermoset properties and have a scratch-resistant surface. The degree of crosslinking of the binders is mostly >50% by weight, preferably >90% by weight. The moldings absorb various amounts of moisture, depending on the fibers used and on the atmospheric conditions. They have ideal resistance to moisture and heat. By way of example, their density is from 0.4 to 1.8 g/cm³, preferably from 0.45 to 1.1 g/cm³. The moldings obtained by the inventive process have a decorative surface and can therefore be used directly as components. For example, this means that the further coating or lamination usual hitherto can be omitted.

Moldings obtainable by the inventive process are used, by way of example, as internal parts of motor vehicles, for example interior door panels, dashboards, side rails, and parcel shelves, as spectacle cases, packing material, such as crates and boxes, in the decorative sector, as single-use tableware, office accessories, as trays, as decorative parts in the furniture industry, or else inserts in closets, or drawers, or for rear walls of furniture. By way of example, they may also be used as internal parts of drawers, or for deadening solid-borne sound.

The percentages given in the examples are percentages by weight.

### EXAMPLES

### Example 1

The process is suitable for using mainly renewable raw materials to produce a low-cost material which itself meets the stringent requirements of the automotive industry.

Besides products for the automotive industry, this process can also open up many other application sectors which hitherto have continued to use straight plastics.

Production of a Semifinished Product

A carded nonwoven was first produced from hemp and kenaf in a ratio by weight of 1:1 with a weight per unit area of 1080 g/m². The nonwoven was then impregnated with 30%, based on the weight of the nonwoven, of a mixture composed of Acrodur® 950 L (binder based on a colorless to slightly yellow, clear 50% strength aqueous solution of a modified polycarboxylic acid with a polyhydric alcohol as crosslinking component) and Acronal® 32D (aqueous dispersion of a copolymer based on polyacrylate) in a ratio by weight of 3:1. After the material had passed through a nip unit, a doctor was used to apply a layer of Acrodur® 950 L foam colored with 2% of C.I. Pigment Blue 15, 15:1 (Disperse Blue 69-1117 from BASF) to the impregnated nonwoven. The density of the foam was 200 g/l, and the amount of foam applied to the nonwoven was 150 g/m², based in each case on the dry weight. The entire composite was then dried at 120° C. for a period of 2.5 min. to give a residual moisture level of 18%. The sheeting product was cut to give mats of dimensions 1000×770 mm.

To test the usefulness of these mats as semifinished product, they were enclosed in air-tight packaging and stored at room temperature for 3 weeks. After this, they always retained adequate flexibility. No sign of fungal mold formation was found.

Production of a Molding

The semifinished product described above was press-molded in a mold for door panels under the following condtions:
mold surface temperature 200° C.
pressure 200 t (20 kg/cm²)
minimum separation between lower mold and upper mold 1.85 mm
pressure cycle 1: 8 sec. at mold separation 6 mm, 5 sec. open
pressure cycle 2: 10 sec. at mold separation 6 mm, 5 sec. open
pressure cycle 3: 30 sec. at mold separation 1.85 mm.
   Removal of the Component after the Third Pressure Cycle.

A large amount of steam escaped with loud hissing during the first pressure cycle. The amount of steam during the second pressure cycle was approximately half. The component could be removed with ease from the press after the third pressure cycle. It did not adhere to the mold.

By the time the molding was removed from the press it had attained almost its final stiffness. Measurement of thickness directly after the press-molding process gave a value of 1.85 mm, the value after conditioning in standard atmospheric conditions being 1.86 mm, implying a dimensional change of 0.5%.

The surface of the molding was compact, and no residual fiber structures were observable. Subjectively assessed surface hardness was good, and the surface could not be damaged by scratching with a fingernail.

1. A process for producing semifinished products from sheet-like fiber structures and from binders, which comprises first
(i) treating a sheet-like fiber structure with a binder,
(ii) coating the surface of the resultant treated fiber structure on one or both sides with a curable binder, and
(iii) drying the coated fiber structure to a residual moisture content of from 4 to 30% by weight.

2. The process according to claim 1, wherein, after the treatment with a binder according to step (i) of the process, the sheet-like fiber structure is dried to a moisture content of from 4 to 30% by weight.

3. The process according to claim 1 or 2, wherein the drying of the binder-treated fiber structure is carried out at a temperature below the temperature at which the binders crosslink.

4. The process according to any of claims 1 to 3, wherein, in step (i) of the process, the amount used of the binder is from 0.5 to 40% by weight, based on the solids content of the binders and the sheet-like fiber structures.

5. The process according to any of claims 1 to 4, wherein, in step (i) of the process, the amount used of the binder is from 15 to 30% by weight, based on the solids content of the binders and the sheet-like fiber structures.

6. The process according to any of claims 1 to 5, wherein the binder used comprises formaldehyde-free heat-curable binders.

7. The process according to any of claims 1 to 6, wherein the sheet-like fiber structure is a woven, knitted, or nonwoven.

8. The process according to claim 7, wherein the fiber structure is composed of natural or synthetic fibers, or of a mixture of these.

9. The process according to any of claims 1 to 8, wherein, in step (ii) of the process, the binder-treated sheet-like fiber structure is coated with a foam-like, curable binder.

10. The process according to any of claims 1 to 9, wherein, in step (ii) of the process, the binder-treated sheet-like fiber structure is coated with a paste-like, curable binder.

11. The process according to any of claims 1 to 10, wherein the amount of curable binders used in step (ii) of the process is from 0.5 to 30% by weight, based on the solids content of the product obtained in stage (i) of the process.

12. The process according to any of claims 1 to 11, wherein the amount of curable binders used in step (ii) of the process is from 1 to 20% by weight, based on the solids content of the product obtained in stage (i) of the process.

13. The process according to any of claims 1 to 12, wherein the amount of curable binders used in step (ii) of the process is from 2 to 10% by weight, based on the solids content of the product obtained in stage (i) of the process.

14. The process according to any of claims 1 to 13, wherein the binder used in step (ii) of the process has been colored.

15. A semifinished product, obtainable by the process according to any of claims 1 to 14.

16. A process for producing moldings, which comprises heating a semifinished product obtainable according to claims 1 to 14 to a temperature above the temperature at which the binders crosslink.

17. The process according to claim 16, wherein, for shaping and curing of the binders, the semifinished product is heated in a press to a temperature in the range from 100 to 260° C., preferably from 180 to 220° C.

18. A molding obtainable by the process of claims 16 to 17.

19. The use of the moldings according to claim 18 as internal parts of motor vehicles, as packing material, as single-use tableware, as office accessories, as decorative parts in the furniture industry, or else as inserts for closets, or drawers, or rear walls of furniture.
